(19) United States
(12) Patent Application Publication
(10) Pub. No.: US 2007/0270280 A1
(43) Pub. Date: Nov. 22, 2007

(54) OPERATING DEVICE AND METHOD OF AN APPARATUS

(75) Inventor: Hideki Takamatsu, Susono-shi (JP)

Correspondence Address: SUGHRUE MION, PLLC, 2100 PENNSYLVANIA AVENUE, N.W., SUITE 800, WASHINGTON, DC, 20037, US

(73) Assignee: Toyota Jidosha Kabushiki Kaisha, Toyota-shi (JP)

(21) Appl. No.: 11/736,706

(22) Filed: Apr. 18, 2007

(30) Foreign Application Priority Data
May 16, 2006 (JP) 2006-136799

(51) Int. Cl. F16H 61/16

(52) U.S. Cl. 477/125

(57) ABSTRACT

An operating device of an apparatus which operates in response to operation of an operating member by a driver includes a detecting device which detects a running state of a vehicle; a setting apparatus which sets, according to the detected running state, a range of a control value controlled by the apparatus; and a control apparatus which controls, depending on whether or not the control value is in the range, reaction force applied to the operating member when the driver operates the operating member.

### INCORPORATION BY REFERENCE

The disclosure of Japanese Patent Application No. 2006-136799 filed on May 16, 2006, including the specification, drawings and abstract is incorporated herein by reference in its entirety.

### BACKGROUND OF THE INVENTION

1. Field of the Invention

The invention relates to an operating device and method of an apparatus, and more particularly, to an operating device and method of an apparatus which operates in response to an operation by a driver.

2. Description of the Related Art

Conventionally, driving force and braking force of a vehicle are controlled by a driver selectively operating a shift lever, accelerator pedal, and a brake pedal. The driving force and braking force are increased or decreased according to the operating amounts of these members.

In order to operate the shift lever, accelerator pedal, and brake pedal, the necessary load must be applied to them or else they will not operate. That is, reaction force is applied against an operation by the driver when the driver operates a member such as the shift lever, accelerator pedal, and brake pedal. Accordingly, a specific operation can be inhibited by changing the reaction force.

Japanese Patent Application Publication No. JP-A-2005-2844 describes an operating device for a vehicle, which electrically generates an operating load on at least one of an accelerator pedal or a shift lever of a vehicle using drive-by-wire. This operating device includes an electromagnetic brake that generates electromagnetic force as an operating load and at least one of an electric motor that generates rotary driving force as an operating load and a spring that mechanically generates an operating load. The operating load is generated in the operating device by the drive-by-wire. If the shift lever is operated in an upshift or downshift direction and there is no effect as a result, the operating load in the direction in which there is no effect is increased.

According to the operating device for a vehicle described in this publication, the drive-by-wire can generate an operating load on the operating device and efficiently control the operating load and operating sensation (i.e., feeling) of at least one of the accelerator or the shift lever of the vehicle. Also, shifting the shift lever forward shifts the transmission successively into first speed, second speed and so on. Shifting the shift lever forward beyond the highest speed has no effect. In this case, the operating load with respect to the operation to shift the shift lever forward becomes heavier, thus limiting forward movement of the shift lever. In this manner, an appropriate operating load is applied to the driver and the transmission can be appropriately controlled.

There may be times when an operation by the driver may have an undesirable effect on vehicle behavior. For example, if a downshift is performed by operating the shift lever when the engine is running at a high speed, the engine speed would become excessively high. Also, if a downshift is performed by operating the shift lever when the vehicle is traveling on a road surface with a low friction coefficient (i.e., hereinafter also referred to as “low μ road”), the driving force may become excessive and the vehicle may slip. However, Japanese Patent Application Publication No. JP-A-2005-2844 makes no mention of operations that may have undesirable effects on vehicle behavior.

### SUMMARY OF THE INVENTION

This invention thus provides an operating device and method of an apparatus, which can inhibit an operation that may have an undesirable effect on vehicle behavior.

A first aspect of the invention relates to an operating device of an apparatus which operates in response to operation of an operating member by a driver. This operating device includes a detecting device which detects a running state of a vehicle; a setting apparatus which sets, according to the detected running state, a range within which a control value controlled by the apparatus is allowed to change; and a control apparatus which controls, depending on whether or not the control value is in the range, reaction force applied to the operating member when the driver operates the operating member,

According to this first aspect, the range within which the control value that is controlled by the apparatus is allowed to change is set according to the detected running state of the vehicle. For example, the range may be set such that an upper limit value of a speed ratio of a transmission is lower the higher the engine speed, or the range may be set such that the upper limit value of the speed ratio of the transmission is lower the lower the friction coefficient of the road surface. The reaction force generated when the driver operates the operating member is controlled depending on whether or not the control value is in the range. For example, control may be performed such that the reaction force is greater when the control value is outside of the range compared to when the control value is within the range. Accordingly, an operation that would increase the speed ratio can be inhibited when the engine speed is high or when the vehicle is traveling on a low μ road. Therefore, when the engine speed is high it can be suppressed from becoming even higher or the driving force can be suppressed from becoming excessive on a low μ road. As a result, an operating device of an apparatus can be provided which is able to inhibit an operation that may have an undesirable effect on vehicle behavior.

With an operating device of an apparatus according to a second aspect of the invention, in addition to the structure of the first aspect, the control apparatus includes a portion that performs control such that the reaction force is greater when the control value is outside of the range compared to when the control value is within the range.

According to this second aspect, control is performed such that the reaction force is greater when the control value is outside of the range compared to when the control value is within the range. As a result, an operation which may change the control value so that it would be outside of the allowed range can be inhibited.

With an operating device of an apparatus according to a third aspect of the invention, in addition to the structure of the first or second aspects, the apparatus is a transmission and the control value is a speed ratio.

According to this third aspect, an operation that would change the speed ratio so that it would be outside of the allowed range can be inhibited.

With an operating device of an apparatus according to a fourth aspect of the invention, in addition to the structure of the third aspect, the setting apparatus includes a portion that sets the range such that an upper limit value is lower the higher an engine speed.

According to this fourth aspect, the range is set such that the upper limit value is lower the higher the engine speed. Accordingly, an operation that would increase the speed ratio can be inhibited when the engine speed is high, thus suppressing the engine speed from becoming excessively high.

With an operating device of an apparatus according to a fifth aspect of the invention, in addition to the structure of the third aspect, the setting apparatus includes a portion that sets the range such that an upper limit value is lower the lower a friction coefficient of a road surface.

According to this fifth aspect, the range is set such that the upper limit value is lower the lower the friction coefficient of the road surface. Accordingly, an operation that would increase the speed ratio can be inhibited while the vehicle is traveling on a low μ road. Therefore, the driving force can be suppressed from becoming excessive on a low μ road, thus inhibiting the vehicle from slipping.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a skeleton view of a vehicle provided with an operating device according to an example embodiment of the invention;

FIG. 2 is a control block diagram of the vehicle provided with the operating device according to the example embodiment of the invention;

FIG. 3 is a diagram (part 1) of a hydraulic pressure control circuit;

FIG. 4 is a diagram (part 2) of the hydraulic pressure control circuit;

FIG, 5 is a diagram (part 3) of the hydraulic pressure control circuit;

FIG. 6 is a first view of a shift lever which moves inside a gate;

FIG. 7 is a block diagram of an ECU shown in FIG. 2;

FIG. 8 is a graph showing a base value of reaction force on the shift lever;

FIG. 9 is a graph showing an upper limit value of a speed ratio at which the engine speed will become lower than a predetermined value;

FIG. 10 is a graph showing an upper limit value of a speed ratio at which it is thought that the vehicle will not slip;

FIG. 11 is a flowchart (part 1) illustrating the structure of control in a program executed by the ECU;

FIG. 12 is a flowchart (part 2) that is a continuation of the flowchart in FIG. 11, illustrating the structure of control in the program executed by the ECU;

FIG. 13 is a graph showing the shift in reaction force on the shift lever; and

FIG. 14 is a second view of the shift lever that moves inside the gate.

### DETAILED DESCRIPTION OF THE PREFERRED EMBODIMENTS

Hereinafter, example embodiments of the invention will be described in detail with reference to the accompanying drawings. In the following description, like parts with be denoted by like reference numerals. Like parts will also be referred to by the same nomenclature and will have the same function. Therefore, detailed descriptions of those parts will not be repeated.

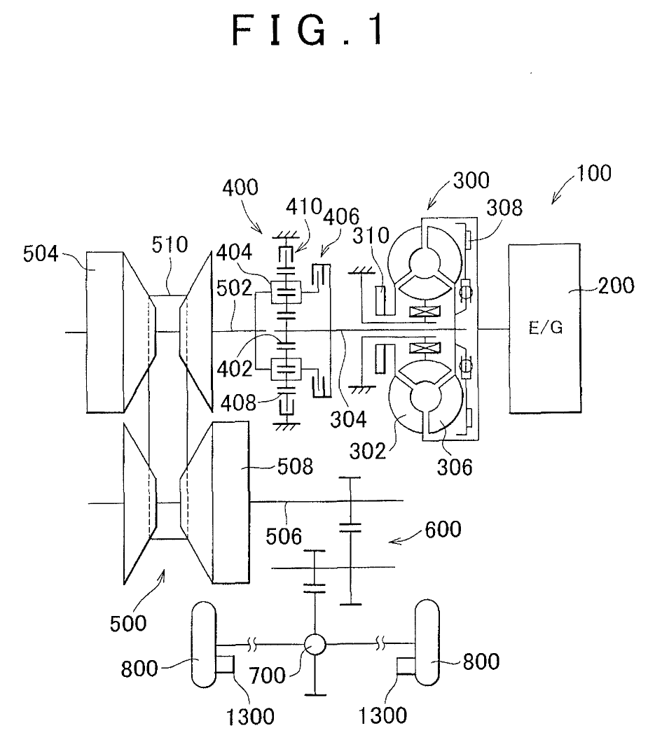

A vehicle provided with an operating device according to an example embodiment of the invention will now be described with reference to FIG. 1. Output of an engine 200 in a powertrain 100 provided in a vehicle is input to a belt-type continuously variable transmission (hereinafter also simply referred to as “CVT”) 500 via a torque converter 300 and a forward-reverse switching apparatus 400. Output from the CVT 500 is transmitted to reduction gears 600 and a differential gear unit 700, and then distributed to left and right driven wheels 800. Rotation of the driven wheels 800 is controlled by a brake system 1300 which suppresses rotation of the driven wheels 800 using frictional force,

The powertrain 100 is controlled by an ECU (Electronic Control Unit) 900 which will be described later. A toroidal-type continuously variable transmission or the like may also be used instead of the CVT 500.

The torque converter 300 includes a pump impeller 302 which is connected to a crankshaft of the engine 200, and a turbine runner 306 which is connected to the forward-reverse switching apparatus 400 via a turbine shaft 304. A lockup clutch 308 is provided between the pump impeller 302 and the turbine runner 306. The lockup clutch 308 is engaged or released by switching a supply of hydraulic pressure to between an engaging side fluid chamber and a release side fluid chamber.

When the lockup clutch 308 is fully engaged, the pump impeller 302 and the turbine runner 306 rotate together as a single unit. A mechanical oil pump 310 is provided with the pump impeller 302. This mechanical oil pump 310 generates hydraulic pressure used to control the shifting of the CVT 500, apply belt pressure (grip) on the belt, and supply lubrication oil to various parts.

The forward-reverse switching apparatus 400 includes a double pinion type planetary gear set. The turbine shaft 304 of the torque converter 300 is connected to a sun gear 402 of the planetary gear set, an input shaft 502 of the CVT 500 is connected to a carrier 404 of the planetary gear set, and the carrier 404 and the sun gear 402 are selectively connected together via a forward clutch 406. A ring gear 408 of the planetary gear set is selectively fixed to a housing via a reverse brake 410. The forward clutch 406 and the reverse brake 410 are frictionally engaged by a hydraulic cylinder. The input rotation speed of the forward clutch 406 is the same as the rotation speed of the turbine shaft 304, i.e., the turbine speed NT.

The forward-reverse switching apparatus 400 is controlled to a state for forward running by engaging the forward clutch 406 and releasing the reverse brake 410. In this state, forward driving force is transmitted to the CVT 500. The forward-reverse switching apparatus 400 is controlled to a state for running in reverse by engaging the reverse brake 410 and releasing the forward clutch 406. In this state, the input shaft 502 is rotated in the opposite direction as the turbine shaft 304, i.e., in reverse. As a result, reverse driving force is transmitted to the CVT 500. Releasing both the forward clutch 406 and the reverse brake 410 places the forward-reverse switching apparatus 400 in a neutral state in which the transmission of power is interrupted.

The CVT 500 includes a primary pulley 504 provided on the input shaft 502, a secondary pulley 508 provided on an output shaft 506, and a transmission belt 510 which is wound around the primary pulley 504 and the secondary pulley 508. Power is transmitted using frictional force between the pulleys and the transmission belt 510.

Each pulley is formed of a hydraulic cylinder, which enables the groove widths of the pulleys to be changed by controlling the hydraulic pressure in the hydraulic cylinders of the pulleys. When the groove width of the one of the pulleys changes, the winding radius of the transmission belt 510 around that pulley (also referred to as “pitch radius”) also changes. The ratio of the pitch radius on the primary pulley 504 to the pitch radius on the secondary pulley 508 determines the speed ratio GR (i.e., speed ratio GR=primary pulley speed NIN/secondary pulley speed NOUT). This speed ratio GR changes in a continuous fashion as the pitch radii of the two pulleys change relative to one another.

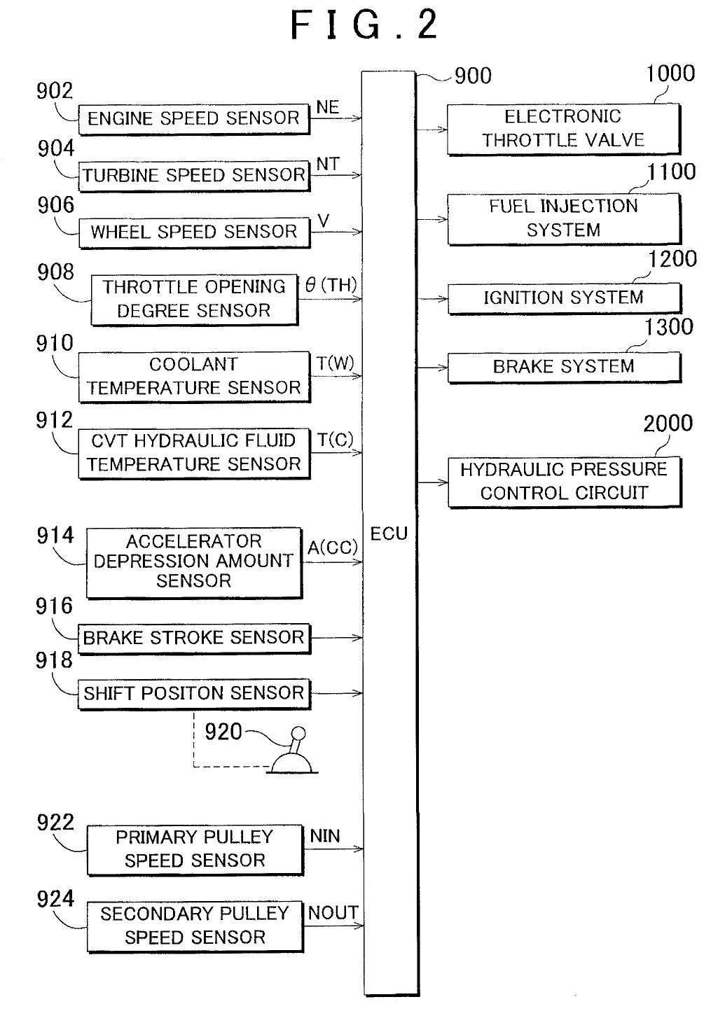

As shown in FIG. 2, the ECU 900 is connected to various sensors, including an engine speed sensor 902, a turbine speed sensor 904, a wheel speed sensor 906, a throttle opening degree sensor 908, a coolant temperature sensor 910, a hydraulic fluid temperature sensor 912, an accelerator depression amount sensor 914, a brake stroke sensor 916, a shift position sensor 918, a primary pulley speed sensor 922, and a secondary pulley speed sensor 924.

The engine speed sensor 902 detects the speed of the engine 200 (i.e., engine speed) NE. The turbine speed sensor 904 detects the rotation speed of the turbine shaft 304 (i.e., turbine speed) NT. The wheel speed sensor (also referred to as “vehicle speed sensor”) 906 detects the speed (i.e., rotation speed) of each wheel (also referred to as “wheel speed”) of the vehicle. The vehicle speed V can be detected from the wheel speed.

The throttle opening degree sensor 908 detects an opening degree θ (TM) of an electronic throttle valve. The coolant temperature sensor 910 detects a coolant temperature T (W) of the engine 200. The hydraulic fluid temperature sensor 912 detects a temperature T (C) of the hydraulic fluid in the CVT 500 and the like. The accelerator depression amount sensor 914 detects a depression amount A (CC) of an accelerator pedal. The brake stroke sensor 916 detects an operating amount (i.e., stroke amount) of a brake pedal. The shift position sensor 918 detects a position (i.e., stroke) of a shift lever 920. The primary pulley speed sensor 922 detects the rotation speed NIN of the primary pulley 504, and the secondary pulley speed sensor 924 detects the rotation speed NOUT of the secondary pulley 508. Signals indicative of the detection results from the various sensors are output to the ECU 900. The turbine speed NT matches the primary pulley speed NIN when the vehicle is traveling forward with the forward clutch 406 engaged. The vehicle speed V is a value that corresponds to the secondary pulley speed NOUT. Therefore, when the vehicle is stopped and the forward clutch 406 is engaged, the turbine speed NT is zero.

The ECU 900 includes a CPU (Central Processing Unit), memory, an input/output interface, and the like. The CPU performs signal processing according to programs stored in memory to execute various controls such as output control of the engine 200, shift control of the CVT 500, belt pressure control, engage/release control of the forward clutch 406, and engage/release control of the reverse brake 410.

Output control of the engine 200 is performed by an electronic throttle valve 1000, a fuel injection system 1100, an ignition system 1200, and the like. The shift control of the CVT 500, the belt pressure control, the engage/release control of the forward clutch 406, and the engage/release control of the reverse brake 410 are all performed by a hydraulic pressure control circuit 2000.

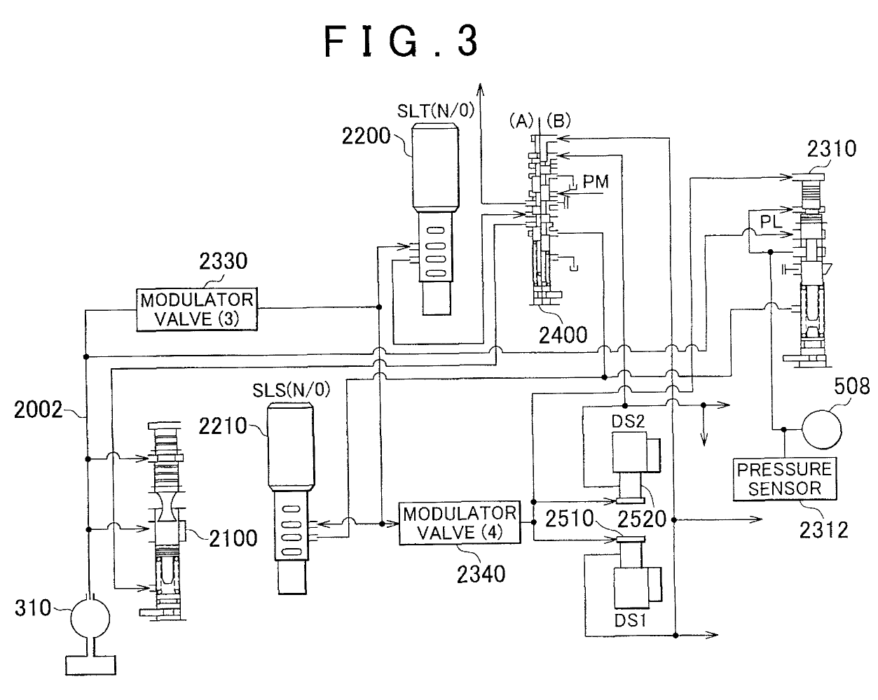

A portion of the hydraulic pressure control circuit 2000 will now be described with reference to FIG. 3. Hydraulic pressure generated by the oil pump 310 is supplied via a line pressure fluid passage 2002 to a primary regulator valve 2100, a modulator valve (1) 2310, and a modulator valve (3) 2330.

Control pressure is selectively supplied from either an SLT linear solenoid valve 2200 or an SLS linear solenoid valve 221 0 to the primary regulator valve 2100. In this example embodiment, both the SLT linear solenoid valve 2200 and the SLS linear solenoid valve 2210 are normally open solenoid valves (i.e., solenoid values which output maximum hydraulic pressure when de-energized). The SLT linear solenoid valve 2200 and the SLS linear solenoid valve 2210 may also be normally closed solenoid valves (i.e., solenoid valves which output minimum (zero) hydraulic pressure when de-energized).

A spool of the primary regulator valve 2100 slides up and down in response to the supplied control pressure. Thus, the primary regulator valve 2100 regulates (adjusts) the hydraulic pressure generated by the oil pump 310. The hydraulic pressure that has been regulated by the primary regulator valve 2100 is used as the line pressure PL. In this example embodiment, the line pressure PL increases the greater the control pressure supplied to the primary regulator valve 2100. Incidentally, the line pressure PL may also be made to progressively decrease the greater the control pressure supplied to the primary regulator valve 2100.

Hydraulic pressure that has been adjusted by the modulator valve (3) 2330 is supplied with the line pressure PL as the base pressure to the SLT linear solenoid valve 2200 and the SLS linear solenoid valve 2210.

The SLT linear solenoid valve 2200 and the SLS linear solenoid valve 2210 generate control pressure according to a current value determined by a duty signal output from the ECU 900.

A control valve 2400 selects the control pressure to be supplied to the primary regulator valve 2100 from among the control pressure (output hydraulic pressure) of the SLT linear solenoid valve 2200 and the control pressure (output hydraulic pressure) of the SLS linear solenoid valve 2210.

When the spool of the control valve 2400 is in state (A) (i.e., the state shown on the left side of the valve) in FIG. 3, control pressure is supplied to the primary regulator valve 2100 from the SLT linear solenoid valve 2200. That is, the line pressure PL is controlled according to the control pressure of the SLT linear solenoid valve 2200.

When the spool of the control valve 2400 is in state (B) (i.e., the state shown on the right side of the valve) in FIG. 3, control pressure is supplied to the primary regulator valve 2100 from the SLS linear solenoid valve 2210. That is, the line pressure PL is controlled according to the control pressure of the SLS linear solenoid valve 2210.

When the spool of the control valve 2400 is in state (B) in FIG. 3, control pressure of the SLT linear solenoid valve 2200 is supplied to a manual valve 2600 which will be described later.

The spool of the control valve 2400 is urged in one direction by a spring and hydraulic pressure from a shift control duty solenoid (1) 2510 and a shift control duty solenoid (2) 2520 is supplied against the urging force of the spring.

When hydraulic pressure is supplied to the control valve 2400 from both the shift control duty solenoid (1) 2510 and the shift control duty solenoid (2) 2520, the spool of the control valve 2400 is shifted into state (3) in FIG. 3.

When hydraulic pressure is not being supplied to the control valve 2400 from at least one of the shift control duty solenoid (1) 2510 and the shift control duty solenoid (2) 2520, the spool of the control valve 2400 is shifted into state (A) in FIG. 3 by the urging force of the spring.

Hydraulic pressure that has been adjusted by a modulator valve (4) 2340 is supplied to the shift control duty solenoid (1) 2510 and the shift control duty solenoid (2) 2520. The modulator valve (4) 2340 adjusts the hydraulic pressure supplied from the modulator valve (3) 2330 to a constant pressure.

The modulator valve (1) 2310 outputs hydraulic pressure that has been adjusted with the line pressure PL as the base pressure. The hydraulic pressure output from the modulator valve (1) 2310 is supplied to the hydraulic cylinder of the secondary pulley 508. This hydraulic pressure is a hydraulic pressure that will not allow the transmission belt 510 to slide.

A spool that is slidable in the axial direction and a spring that urges the spool in one direction are provided in the modulator valve (1) 2310. The modulator valve (1) 2310 adjusts the line pressure PL introduced to the modulator valve (1) 2310 with the output hydraulic pressure of the SLS linear solenoid valve 2210 which is duty controlled by the ECU 900 as the pilot pressure. The hydraulic pressure that has been adjusted by the modulator valve (3) is supplied to the hydraulic cylinder of the secondary pulley 508. The belt pressure (grip) is increased or decreased according to the output hydraulic pressure from the modulator valve (I) 2310.

The SLS linear solenoid valve 2210 is controlled according to a map having the accelerator depression amount A (CC) and the speed ratio GR as parameters such that belt pressure which does not allow the belt to slip is generated. More specifically, exciting current to the SLS linear solenoid valve 2210 is controlled by a duty ratio corresponding to the belt pressure. When there is a sudden change in the transfer torque, such as during acceleration or deceleration, slipping of the belt may also be suppressed by increasing the belt pressure.

The hydraulic pressure supplied to the hydraulic cylinder of the secondary pulley 508 is detected by a pressure sensor 2312.

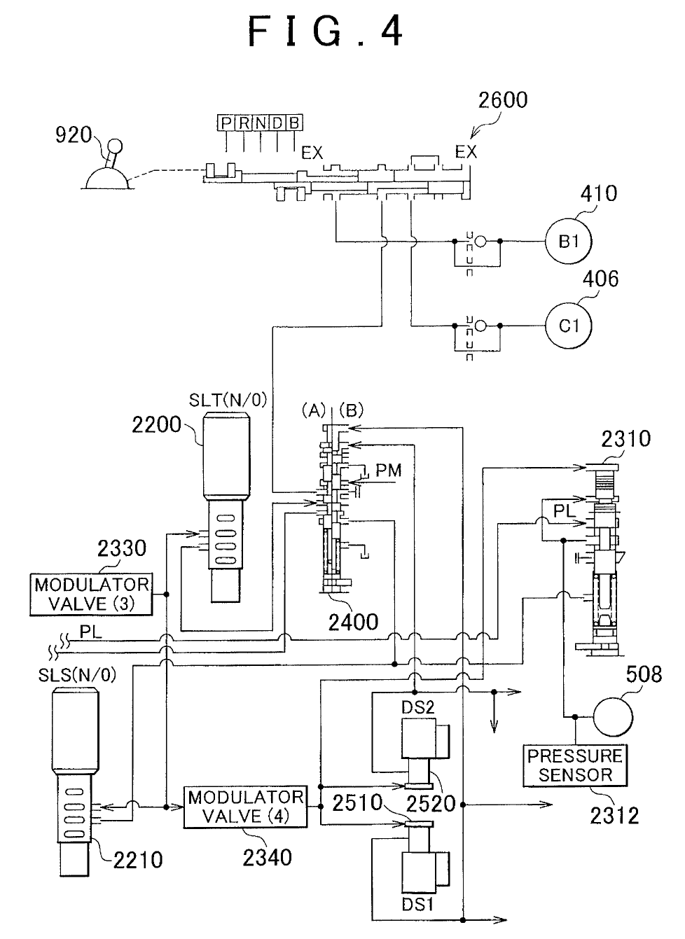

The manual valve 2600 will now be described with reference to FIG. 4.

The manual valve 2600 is mechanically switched according to an operation of the shift lever 920. When the manual valve 2600 is switched, the forward clutch 406 and the reverse brake 410 engage or release depending on the state of the manual valve 2600.

The shift lever 920 can be shifted into various positions, i.e., a “P” position for parking, an “R” position for running in reverse, an “N,” position in which the transfer of power is interrupted, and “D” and “B” positions for forward running.

When the shift lever 920 is shifted into the “P” position or the “N” position, hydraulic pressure in the forward clutch 406 and the reverse brake 410 drains from the manual valve 2600 so the forward clutch 406 and the reverse brake 41 0 release.

When the shift lever 920 is shifted into the “R” position, hydraulic pressure is supplied from the manual valve 2600 to the reverse brake 410 so the reverse brake 410 engages, while hydraulic pressure in the forward clutch 406 drains from the manual valve 2600 so the forward clutch 406 releases.

When the control valve 2400 is in state (A) (i.e., the state shown on the left side of the valve) in FIG. 4 while the shift lever 920 is in the “R” position, modulator pressure PM supplied from a modulator valve (2), not shown, is supplied to the manual valve 2600 via the control valve 2400. This modulator pressure PM keeps the reverse brake 410 engaged.

When the control valve 2400 is in state (B) (i.e., the state shown on the right side of the valve) in FIG. 4 while the shift lever 920 is in the “R” position, hydraulic pressure that has been adjusted by the SLT linear solenoid valve 2200 is supplied to the manual valve 2600. Adjusting the pressure with the SLT linear solenoid valve 2200 enables the reverse brake 410 to be engaged gradually, thus suppressing shock when the reverse brake 410 is engaged.

When the shift lever 920 is shifted into the “D” position or the “B” position, hydraulic pressure is supplied from the manual valve 2600 to the forward clutch 406 such that the forward clutch 406 engages, while hydraulic pressure in the reverse brake 410 drains from the manual valve 2600 so the reverse brake 410 releases.

When the control valve 2400 is in state (A) (i.e., the state shown on the left side of the valve) in FIG. 4 while the shift lever 920 is in the “D” or “B” position, modulator pressure PM supplied from the modulator valve (2), not shown, is supplied to the manual valve 2600 via the control valve 2400. This modulator pressure PM keeps the forward clutch 406 engaged.

When the control valve 2400 is in state (B) (i.e., the state shown on the right side of the valve) in FIG. 4 while the shift lever 920 is in the “D” or “B” position, hydraulic pressure that has been adjusted by the SLT linear solenoid valve 2200 is supplied to the manual valve 2600. Adjusting the pressure with the SLT linear solenoid valve 2200 enables the forward clutch 406 to be engaged gradually, thus suppressing shock when the forward clutch 406 is engaged.

The SLT linear solenoid valve 2200 normally controls the line pressure PL via the control valve 2400, and the SLS linear solenoid valve 2210 normally controls the belt pressure via the modulator valve (1) 2310.

On the other hand, when a neutral control executing condition that includes a condition in which the vehicle is stopped (i.e., the vehicle speed is zero) is satisfied while the shift lever 920 is in the “D” position, the SLT linear solenoid valve 2200 controls the engaging force of the forward clutch 406 so that it decreases. The SLS linear solenoid valve 2210 controls the belt pressure via the modulator valve (1) 2310, and also controls the line pressure PL instead of the SLT linear solenoid valve 2200.

When a garage shift, in which the shift lever 920 is shifted from the “N” position to the “D” position or the “R” position, is performed, the SLT linear solenoid valve 2200 controls the engaging force of the forward clutch 406 or the reverse brake 410 so that the forward clutch 406 or the reverse brake 410 engages gradually. The SLS linear solenoid valve 2210 controls the belt pressure via the modulator valve (1) 2310, and also controls the line pressure PL instead of the SLT linear solenoid valve 2200.

The structure that performs shift control will now be described with reference to FIG. 5. Shift control is performed by controlling the supply and discharge of hydraulic pressure to and from the hydraulic cylinder of the primary pulley 504 using a ratio control valve (1) 2710 and a ratio control valve (2) 2720.

Both the ratio control valve (1) 2710 to which line pressure PL is supplied and the ratio control valve (2) 2720 which is connected to a drain are communicated with the hydraulic cylinder of the primary pulley 504.

The ratio control valve (1) 2710 is a valve used for executing an upshift, and is structured such that a flow path between an inlet port to which line pressure PL is supplied and an outlet port which is communicated with the hydraulic cylinder of the primary pulley 504 is opened and closed by a spool.

A spring is arranged at one end of a spool of the ratio control valve (1) 2710. A port through which control pressure from the shift control duty solenoid (1) 2510 is supplied is formed in the end portion opposite the side that the spring is on such that the spool is sandwiched in between. Also, a port through which control pressure from the shift control duty solenoid (2) 2520 is supplied is formed in the end portion on the side where the spring is arranged.

When the control pressure from the shift control duty solenoid (1) 2510 is increased and control pressure is not allowed to be discharged from the shift control duty solenoid (2) 2520, the spool of the ratio control valve (1) 2710 shifts to state (D) (the state shown on the right side of the valve) in FIG. 5.

In this state, the hydraulic pressure supplied to the hydraulic cylinder of the primary pulley 504 increases so the groove width of the primary pulley 504 becomes narrower. As a result, the speed ratio decreases, i.e., the transmission upshifts. Also, increasing the amount of operating fluid supplied at this time increases the shifting speed.

The ratio control valve (2) 2720 is a valve used for executing a downshift. Similar to the ratio control valve (1) 2710, a spring is arranged at one end of a spool of the ratio control valve (2) 2720. A port through which control pressure from the shift control duty solenoid (1) 2510 is supplied is formed in the end portion on the side where the spring is arranged. Also, a port through which the control pressure from the shift control duty solenoid (2) 2520 is supplied is formed in the end portion opposite the side that the spring is on such that the spool is sandwiched in between.

When the control pressure from the shift control duty solenoid (2) 2520 is increased and control pressure is not allowed to be discharged from the shift control duty solenoid (2) 2510, the spool of the ratio control valve (2) 2720 shifts to state (C) (the state shown on the left side of the valve) in FIG. 5.

In this state, hydraulic fluid is discharged from the hydraulic cylinder of the primary pulley 504 via the ratio control valve (1) 2710 and the ratio control valve (2720) so the groove width of the primary pulley 504 increases. As a result, the speed ratio increases, i.e., the transmission downshifts. Also, increasing the amount of hydraulic fluid discharged at this time increases the shifting speed.

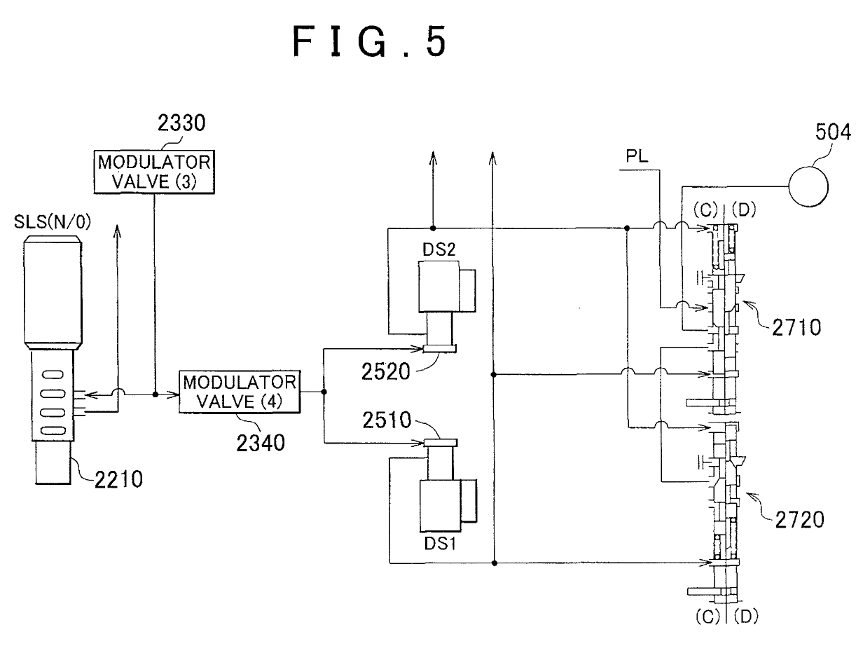

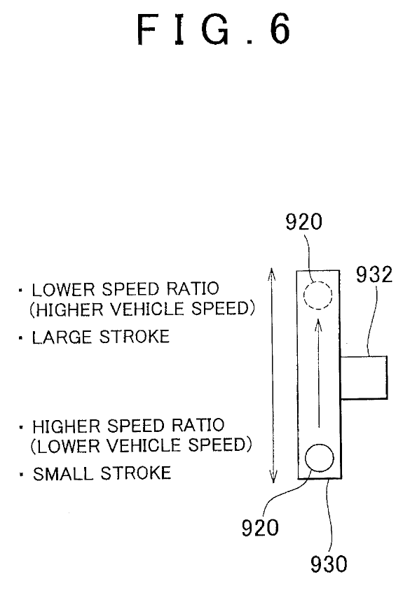

The shift lever 920 will now be further described with reference to FIG. 6. The shift lever 920 is provided so as to move inside a gate 930 and can be stopped anywhere within that gate 930.

In this example embodiment, the CVT 500 is controlled to establish speed ratios corresponding to the various positions in the gate 930. For example, the CVT 500 is controlled to establish a speed ratio for a higher vehicle speed, i.e., a lower speed ratio, the farther up the position of the shift lever 920 is in FIG. 6. Conversely, the CVT 500 is controlled to establish a speed ratio for a lower vehicle speed, i.e., a higher speed ratio, the lower down the position of the shift lever 920 is in FIG. 6.

The method of setting the speed ratio of the CVT 500 is not limited to this. Alternatively, for example, the CVT 500 may be controlled to establish a higher speed ratio the farther up the position of the shift lever 920 is in FIG. 6, and controlled to establish a lower speed ratio the lower down the position of the shift lever 920 is in FIG, 6.

In this example embodiment, the stroke increases the farther up the position of the shift lever 920 in FIG. 6. The load necessary to operate the shift lever 920, i.e., the reaction force the driver feels when operating the shift lever 920, is generated by an electric actuator 932. This electric actuator 932 is controlled by the ECU 900. Known technology may be used to generate the reaction force on the shift lever 920 so the structure used for that purpose will not be described in detail here. The reaction force on the shift lever 920, however, will be described in detail later.

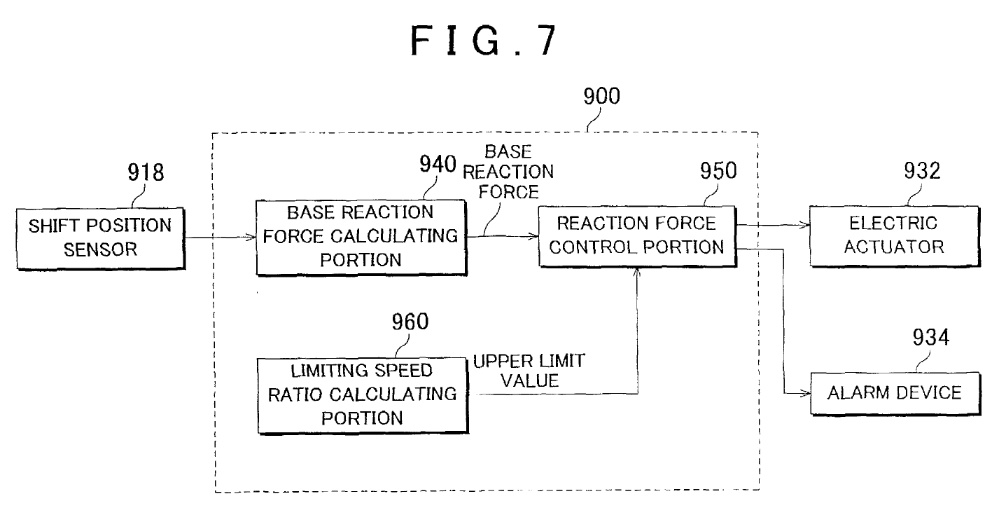

The ECU 900 will further be described with reference to FIG. 7. The ECU 900 includes a base reaction force calculating portion 940, a reaction force controlling portion 950, and a limiting speed ratio calculating portion 960. The base reaction force calculating portion 940 calculates a base value of the reaction force (hereinafter also referred to as “base reaction force”) so that it increases the larger the stroke of the shift lever 920.

Returning now to FIG. 7, the reaction force controlling portion 950 controls the electric actuator 932 to generate a desired reaction force and move the shift lever 920. The reaction force controlling portion 950 also controls an alarm device 934 to alert the driver to the fact that the shift lever 920 is nearing a position (at which a speed ratio would be established) that may have an undesirable effect on vehicle behavior.

The reaction force on the shift lever 920 is determined based on an upper limit value of a speed ratio at which the engine speed will become lower than a predetermined value and an upper limit value of a speed ratio at which it is thought that the vehicle (i.e., the wheels) will not slip, in addition to the base reaction force calculated by the base reaction force calculating portion 940.

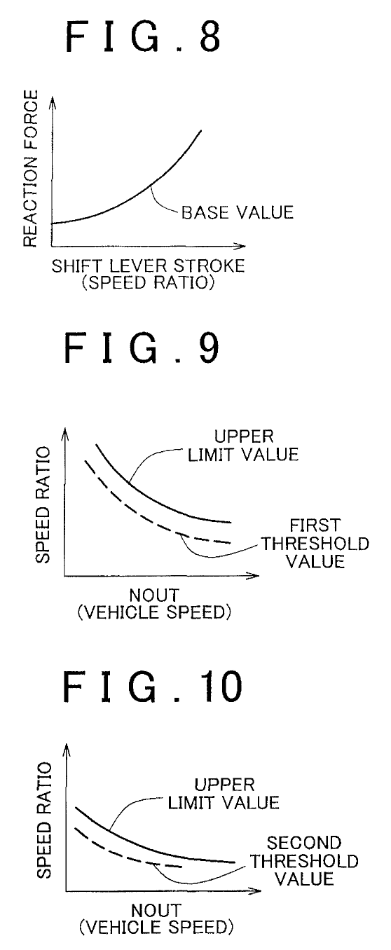

The upper limit value of the speed ratio at which the engine speed will become lower than a predetermined value is set to become lower the higher the secondary pulley speed (i.e., the output shaft rotation speed of the CVT 500) NOUT, i.e., the engine speed, as shown by the solid line in FIG. 9. The upper limit value of the speed ratio at which the engine speed will become lower than a predetermined value is stored in advance in the memory of the ECU 900. This upper limit value defines the range of the speed ratio that is allowed as the speed ratio at which the engine speed will become lower than the predetermined value.

The broken line in FIG. 9 indicates a first threshold value that defines a speed ratio at which the driver is alerted to the fact that the shift lever 920 is nearing a position (at which a speed ratio would be established) that may have an undesirable effect on vehicle behavior.

The upper limit value of the speed ratio at which it is thought that the vehicle will not slip is set based on a map or the like prepared in advance so as to become lower the higher the secondary pulley speed NOUT, as shown by the solid line in FIG. 10. Also, the upper limit value of the speed ratio at which it is thought that the vehicle will not slip is set to become lower the lower the 1 (i.e., friction coefficient) of the road surface. This upper limit value defines the range of the speed ratio that is allowed as the speed ratio at which it is thought that the vehicle will not slip.

The broken line in FIG. 10 indicates a second threshold value that defines a speed ratio at which the driver is alerted to the fact that the shift lever 920 is nearing a position (at which a speed ratio would be established) that may have an undesirable effect on vehicle behavior.

The upper limit value of the speed ratio at which it is thought that the vehicle will not slip (i.e., the solid line in FIG. 10) is set by the limiting speed ratio calculating portion 960. The limiting speed ratio calculating portion 960 sets the upper limit value of the speed ratio at which it is thought that the vehicle will not slip based on the μ (friction coefficient) of the road surface. Here, the μ of the road surface is calculated by the slip ratio of the tires, for example, which is estimated from the rotation speed of the wheels. The IA of the road surface may be calculated by typical technology that is well known so the manner in which it is calculated will not be described in detail here.

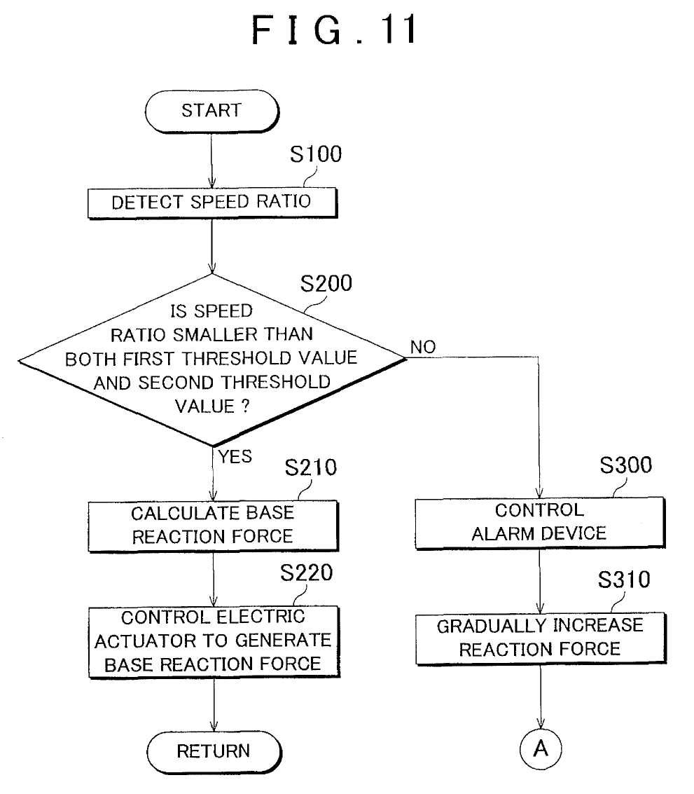

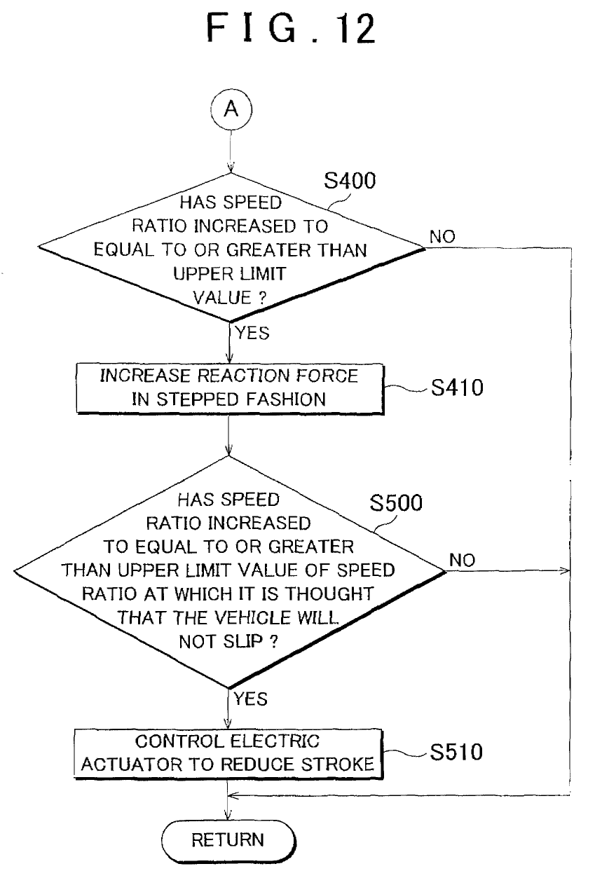

The control structure of a program executed by the ECU 900 will now be described with reference to FIGS. 11 and 12. The program described below is repeatedly executed in predetermined cycles.

In step S8100 the ECU 900 detects the speed ratio of the CVT 500 based on the primary pulley speed NIN and the secondary pulley speed NOUT.

In step S200, the ECU 900 determines whether the speed ratio is lower than both the first threshold value (i.e., the broken line in FIG. 9) and the second threshold value (i.e., the broken line in FIG. 10). If the speed ratio is lower than both the first threshold value and the second threshold value, the process proceeds on to step S210. If not (i.e., NO in step S200), the process proceeds on to step S300. Incidentally, the speed ratio is compared to each threshold value which corresponds to the current secondary pulley speed NOUT.

In step S210, the ECU 900 calculates the base reaction force based on the stroke of the shift lever 920. Then in step S220, the ECU 900 controls the electric actuator 932 to generate that base reaction force.

In step S300, the ECU 900 controls the alarm device 934 to alert the driver using audio means, visual means, or both. Then in step S310, the ECU 900 controls the electric actuator 932 to gradually increase the reaction force as the speed ratio increases.

In step S400, the ECU 900 determines whether the speed ratio has increased to equal to or greater than at least one of i) the upper limit value of the speed ratio at which the engine speed will become lower than a predetermined value (i.e., the solid line in FIG. 9), and ii) the upper limit value of the speed ratio at which it is thought that the vehicle will not slip (i.e., the solid line in FIG. 10). If the speed ratio has increased to equal to or greater than at least one of the upper limit value of the speed ratio at which the engine speed will become lower than a predetermined value and the upper limit value of the speed ratio at which it is thought that the vehicle will not slip (i.e., YES in step S400), the process proceeds on to step S410. If not (i.e., NO in step S400), this cycle of the routine ends. Incidentally, the speed ratio is compared to each upper threshold value which corresponds to the current secondary pulley speed NOUT.

In step S410, the ECU 900 controls the electric actuator 932 to increase the reaction force in a stepped manner.

In step S500, the ECU 900 determines whether the speed ratio has increased to equal to or greater than the upper limit value of the speed ratio at which it is thought that the vehicle will not slip. If the speed ratio has increased to equal to or greater than the upper limit value of the speed ratio at which it is thought that the vehicle will not slip (i.e., YES in step S500), the process proceeds on to step S510. If not (i.e., NO in step S500), this cycle of the routine ends.

In step S510, the ECU 900 controls the electric actuator 932 to reduce the stroke of the shift lever 920 to a predetermined value. That is, the electronic actuator 932 is operated to move the shift lever 920 even if the driver does not operate the shift lever 920.

The operation of the operating device according to this example embodiment which is based on the structure and flowchart described above will now be described.

The speed ratio of the CVT 500 is detected based on the primary pulley speed NIN and the secondary pulley speed NOUT while the vehicle is running (step S100). If the speed ratio is lower than both the first threshold (i.e., the broken line in FIG. 9) and the second threshold (i.e., the broken line in FIG. 10) (i.e., YES in step S200), then even if a downshift is performed such that the speed ratio increases, the engine speed will not become too high and the driving force will not become excessive. In this case, the base reaction force is calculated based on the stroke of the shift lever 920 (step S210) and the electric actuator 932 is controlled to generate this calculated reaction force.

If, on the other hand, the speed ratio is equal to or greater than the first threshold value (i.e., NO in step S200), there is a possibility that the engine speed may become too high if a downshift is performed and the speed ratio increases. Also, an increase in the speed ratio may result in the too much driving force being generated, which may cause the vehicle to slip.

Therefore, if the speed ratio is equal to or greater than at least one of the first threshold and the second threshold (i.e., NO in step S200), the alarm device 934 is controlled to alert the driver using audio means, visual means, or both (step S300).

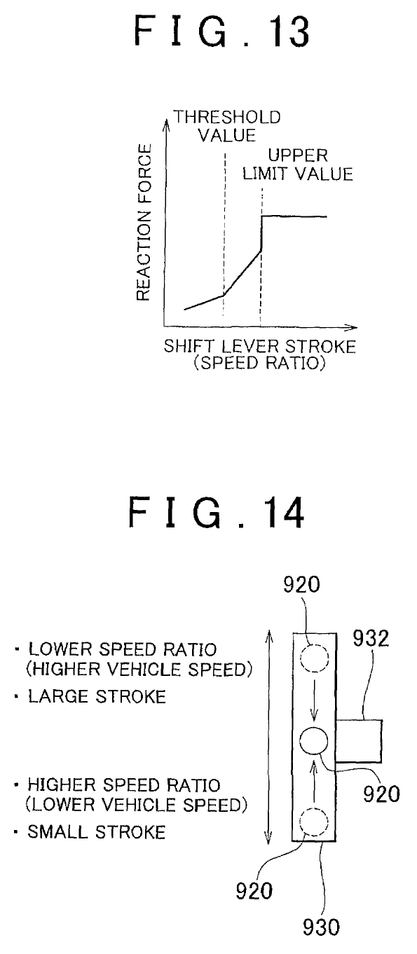

Also, in order to make the shift lever 920 difficult to shift, the electric actuator 932 is controlled (step S310) to gradually increase the reaction force as the speed ratio increases, as shown in FIG. 13.

If the speed ratio increases to at least one of the upper limit value of the speed ratio at which the engine speed will become lower than the predetermined value (indicated by the solid line in FIG. 9) and the upper limit value of the speed ratio at which it is thought that the vehicle will not slip (indicated by the solid line in FIG. 10), the reaction force is greater in a stepped manner as shown in FIG. 13 (step S410). As a result, the shift lever 920 can be made more difficult to operate which inhibits the speed ratio from being increased, and thus inhibiting undesirable vehicle behavior.

If at this time the speed ratio has increased to equal to or greater than the upper limit value of the speed ratio at which it is thought that the vehicle will not slip (i.e., YES in step S500), the electric actuator 932 is controlled to reduce the stroke of the shift lever 920 to a predetermined value (step S510). Accordingly, the speed ratio will decrease unless the driver applies a load to the shift lever 920. As a result, driving force can be reduced, thereby making the vehicle less likely to slip.

As described above, with the operating device according to this example embodiment, if the speed ratio increases to at least one of the upper limit value of the speed ratio at which the engine speed will become less than the predetermined value and the upper limit value of the speed ratio at which it is thought that the vehicle will not slip, the reaction force on the shift lever will increase in a stepped fashion. Accordingly, the shift lever is made more difficult to shift. Therefore, when the engine speed is high, it can be suppressed from becoming even higher and the driving force on a low μ road can be suppressed from becoming excessive. As a result, an operation that may have an undesirable effect on vehicle behavior can be inhibited.

In the foregoing example embodiment, the upper limit value of the speed ratio at which it is thought that the vehicle will not slip is set based on the μ of the road surface. Instead of being set based on the μ of the road surface, however, the upper limit value may also be calculated based on, for example, the execution state of traction control which adjusts the driving force of the vehicle based on the slip ratio of the wheels.

Also, the upper limit value of the speed ratio at which it is thought that the vehicle will not slip may be set using information about the μ of the road surface, rainfall and snowfall, etc. obtained from an infrastructure such as ITS (Intelligent Transport Systems).

Furthermore, the upper limit value of the driving force may be calculated instead of the upper limit value of the speed ratio. Also, in the foregoing example embodiment, the shift lever 920 can be stopped in a variety of given positions within the gate 930. Alternatively, however, as shown in FIG. 14, the shift lever 920 may be made to return to a predetermined position (i.e., the position indicated by the solid line in FIG. 14) using the urging force of a spring or the like if the driver does not apply a load to the shift lever 920.

Moreover, reaction force on the accelerator pedal, the brake pedal, and the steering wheel and the like may also be controlled in addition to the reaction force of the shift lever 920.

The example embodiments disclosed herein are in all respects merely examples and should in no way be construed as limiting. The scope of the invention is indicated not by the foregoing description but by the scope of the claims for patent, and is intended to include all modifications that are within the scope and meanings equivalent to the scope of the claims for patent.

What is claimed is:

1. An operating device of an apparatus which operates in response to operation of an operating member by a driver, comprising:
a detecting device which detects a running state of a vehicle;
a setting apparatus which sets, according to the detected running state, a range of a control value controlled by the apparatus; and
a control apparatus which controls, depending on whether or not the control value is in the range, reaction force applied to the operating member when the driver operates the operating member.

2. The operating device of an apparatus according to claim 1, wherein the control apparatus includes a portion that performs control such that the reaction force is greater when the control value is outside of the range compared to when the control value is within the range.

3. The operating device of an apparatus according to claim 2, wherein the control apparatus includes a portion that performs control to alert the driver when the control value is outside of the range.

4. The operating device of an apparatus according to claim 1, wherein the apparatus is a transmission and the control value is a speed ratio.

5. The operating device of an apparatus according to claim 4, wherein the control apparatus includes a portion that performs control such that a stroke of the operating member is smaller when the speed ratio is outside of the range compared to when the speed ratio is within the range.

6. The operating device of an apparatus according to claim 4, wherein the setting apparatus includes a portion that sets the range such that an upper limit value is lower the higher an engine speed.

7. The operating device of an apparatus according to claim 4, wherein the setting apparatus includes a portion that sets the range such that an upper limit value is lower the lower a friction coefficient of a road surface.

8. An operating method of an apparatus which operates in response to operation of an operating member by a driver, comprising:
a) detecting a running state of a vehicle;
b) controlling a control value with the apparatus;
c) setting, according to the detected running state, a range of the control value; and
d) controlling, depending on whether or not the control value is in the range, reaction force applied to the operating member when the driver operates the operating member.

9. The operating method of an apparatus according to claim 8, wherein step d) includes performing control such that the reaction force is greater when the control value is outside of the range compared to when the control value is within the range.

10. The operating method of an apparatus according to claim 9, wherein step d) includes performing control to alert the driver when the control value is outside of the range.

11. The operating method of an apparatus according to claim 8, wherein the apparatus is a transmission and the control value is a speed ratio.

12. The operating method of an apparatus according to claim 11, wherein step d) includes performing control such that a stroke of the operating member is smaller when the speed ratio is outside of the range compared to when the speed ratio is within the range.

13. The operating method of an apparatus according to claim 11, wherein step c) includes setting the range such that an upper limit value is lower the higher an engine speed.

14. The operating method of an apparatus according to claim 11, wherein step c) includes setting the range such that an upper limit value is lower the lower a friction coefficient of a road surface.
